(19) United States
(12) Patent Application Publication
(10) Pub. No.: US 2012/0148321 A1
(43) Pub. Date: Jun. 14, 2012

(54) CLEANING UNIT AND IMAGE FORMING APPARATUS

(75) Inventor: Takuya Kawakami, Numazu-shi (JP)

(73) Assignee: CANON KABUSHIKI KAISHA, Tokyo (JP)

(21) Appl. No.: 13/312,077

(22) Filed: Dec. 6, 2011

(30) Foreign Application Priority Data
Dec. 8, 2010 (JP) 2010-273910

(51) Int. Cl. G03G 21/00

(52) U.S. Cl. 399/351

(57) ABSTRACT

A cleaning member is supported by a cleaning container by fastening screws with lubricant interposed between support surfaces of the cleaning container and a supporting member of the cleaning member. Accordingly, the difference in the amount of thermal expansion between the cleaning container and the supporting member generated by a change in temperature can be absorbed by sliding of the support surfaces and the supporting member relative to each other.

### BACKGROUND OF THE INVENTION

1. Field of the Invention

The present invention relates to a cleaning unit and an image forming apparatus that employs the cleaning unit.

A cleaning unit includes a cleaning member and a cleaning container. Toner deposited on an image bearing member is removed by the cleaning member and recovered in the cleaning container.

Image forming apparatuses are apparatuses that form an image on a recording medium using, for example, an electrophotograpy image-forming method.

Examples of such an image forming apparatus include electrophotograpy copiers, electrophotograpy printers (LED printers, laser beam printers, etc.), facsimile machines, and word processors.

2. Description of the Related Art

A typical cleaning unit used in an image forming apparatus includes a cleaning member composed of a supporting member made of metal and an elastic member made of an elastic material, and a cleaning container made of resin. The supporting member of the cleaning member is supported by the cleaning container at a plurality of positions in the longitudinal direction, and the elastic member of the cleaning member is deformed and brought into contact with the image bearing member to remove the toner deposited on the image bearing member.

In a configuration in which a metal member is supported by a resin container at a plurality of positions in the longitudinal direction, it is desirable that the difference in the amount of thermal expansion between the supported portions generated by a change in temperature be absorbed because the thermal expansion coefficient of metal is different from that of resin.

Japanese Patent Laid-Open No. 8-006385 discloses a configuration in which a metal member is supported by a resin container such that one end thereof in the longitudinal direction is immovable and the other end thereof is movable.

Japanese Patent Laid-Open No. 11-282251 discloses a configuration in which a metal member is supported by a resin container by fastening fastening members. Therein, at least at one position, the metal member is fastened via an elastic member that presses the metal member.

The relative positions of the image bearing member and the cleaning member in a direction perpendicular to the shaft of the image bearing member need to be precisely and reliably maintained throughout the temperature range that is expected during use of the image forming apparatus.

If these components are assembled with incorrect relative positions, or if their relative positions are changed due to deformation caused by a change in temperature, faulty cleaning may occur.

Therefore, the relative positions of the cleaning container and the cleaning member in the direction perpendicular to the shaft of the image bearing member also need to be precisely and reliably maintained throughout the temperature range that is expected during use of the image forming apparatus.

However, in the configuration in which the supporting member of the cleaning member is supported by the cleaning container by fastening screws at a plurality of positions in the longitudinal direction, the supporting member of the cleaning member is less likely to slide relative to the cleaning container. Therefore, deformation due to the difference in the amount of thermal expansion between the supported portions may occur when the temperature is changed, which may cause a change in the relative positions of the cleaning container and the cleaning member in the direction perpendicular to the shaft of the image bearing member.

Furthermore, in the configuration in which the supporting member of the cleaning member is supported by the cleaning container such that one end thereof in the longitudinal direction is immovable and the other end thereof is movable, the relative positions of the cleaning container and the cleaning member may change in the direction perpendicular to the shaft of the image bearing member by an amount corresponding to a small gap in the movably supported portion at the other end.

In addition, in the configuration in which the supporting member of the cleaning member is supported by the cleaning container via an elastic member, the support strength is low compared with the support structure in which the screws are used.

### SUMMARY OF THE INVENTION

The present invention enables the relative positions of the cleaning container and the cleaning member to be precisely and reliably maintained in the direction perpendicular to the shaft of the image bearing member throughout the temperature range that is expected during use of the image forming apparatus.

Further features of the present invention will become apparent from the following description of exemplary embodiments with reference to the attached drawings.

### BRIEF DESCRIPTION OF THE DRAWINGS

FIGS. 1A to 1C show a support structure of a cleaning container configured to support a cleaning member according to a third embodiment of the present invention.

FIG. 2 is a cross-sectional view of an image-forming-apparatus body of an image forming apparatus and a process cartridge according to a first embodiment of the present invention.

FIG. 3 is a cross-sectional view of the process cartridge according to the first embodiment of the present invention.

FIG. 4 is a perspective view of the process cartridge and the image-forming-apparatus body with a cover open, according to the first embodiment of the present invention.

FIG. 5 is a perspective view showing the configuration of the process cartridge according to the first embodiment of the present invention.

FIG. 6 is a perspective view showing the configuration of a cleaning unit according to the first embodiment of the present invention.

FIG. 7 is a perspective view showing the configuration of a developing unit according to the first embodiment of the present invention.

FIGS. 8A to 8C show a support structure of a cleaning container configured to support a cleaning member according to the first embodiment of the present invention.

FIGS. 9A to 9C show the cleaning container and the cleaning member according to the first embodiment of the present invention, when the temperature is changed.

FIGS. 10A to 10C show a support structure of a cleaning container configured to support a cleaning member according to a second embodiment of the present invention.

FIGS. 11A to 11C show the support structure of the cleaning container configured to support the cleaning member according to the second embodiment of the present invention.

### DESCRIPTION OF THE EMBODIMENTS

### First Embodiment

Embodiments of the present invention will be described in detail below with reference to the drawings.

Herein, the direction of the rotational axis of an image bearing member is assumed to be the longitudinal direction.

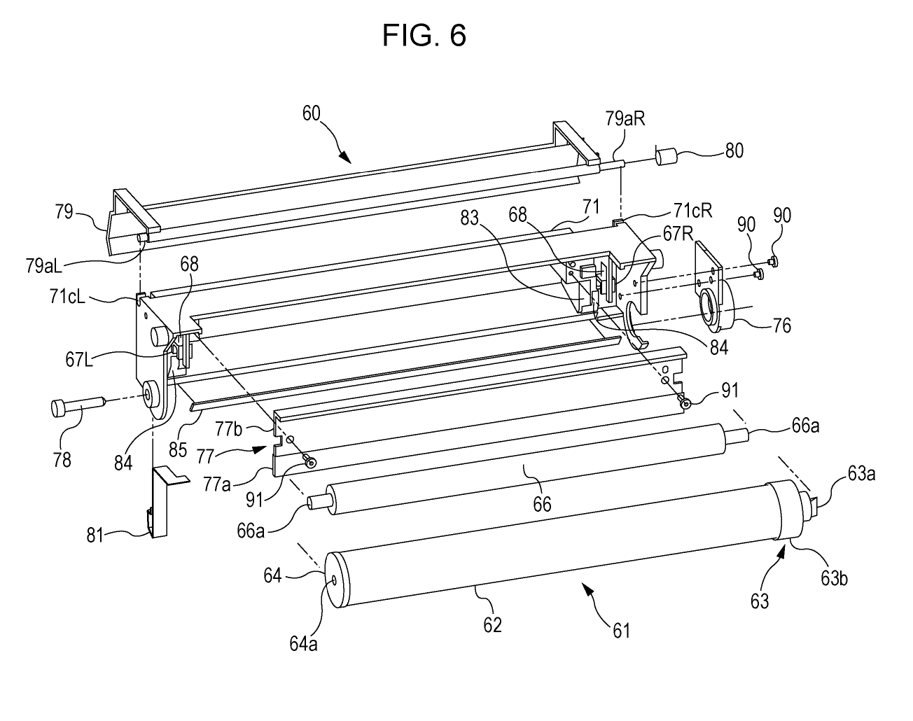

Furthermore, in the longitudinal direction, a side from which the image bearing member receives a driving force from an image-forming-apparatus body is assumed to be a driving side (a driving-force receiving portion 63a in FIG. 6), and a side opposite thereto is assumed to be a non-driving side.

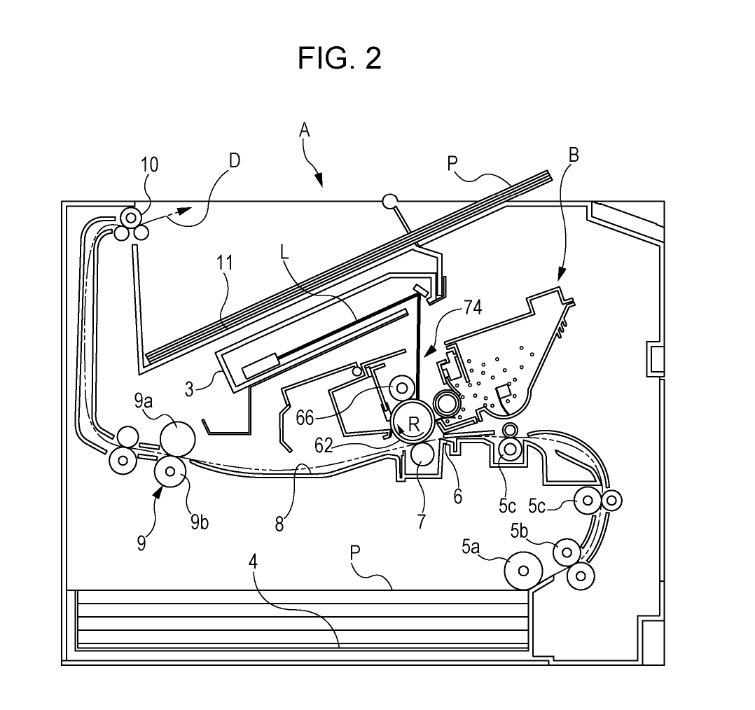

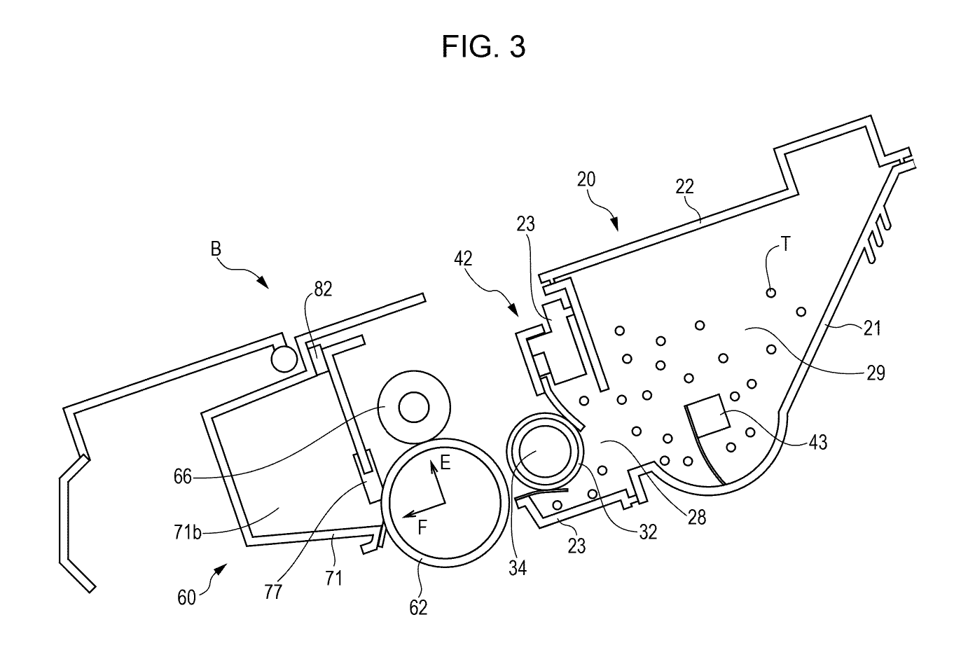

Referring to FIGS. 2 and 3, the overall configuration and an image-forming process will be described.

FIG. 2 is a cross-sectional view of the image-forming-apparatus body (hereinbelow, an “apparatus body A”) of an image forming apparatus as an embodiment of the present invention and a process cartridge (hereinbelow, a “cartridge B”).

FIG. 3 is a cross-sectional view of the cartridge B.

The apparatus body A of the image forming apparatus corresponds to a portion of the image forming apparatus excluding the cartridge B.

### Overall Configuration of Image Forming Apparatus

The image forming apparatus shown in FIG. 2 is a laser beam printer employing an electrophotograpy technology, in which the cartridge B is removably fitted to the apparatus body A. When the cartridge B is fitted to the apparatus body A, an exposure unit 3 (a laser scanner unit) is situated above the cartridge B.

Below the cartridge B is situated a sheet tray 4 that accommodates a recording medium on which an image is formed (hereinbelow, a “sheet material P”).

The apparatus body A includes a pick-up roller 5a, a feeding roller pair 5b, a conveying roller pair 5c, a transfer guide 6, a transfer roller 7, a conveyance guide 8, a fixing unit 9, a discharge roller pair 10, a discharge tray 11, etc., in sequence in a sheet-conveying direction D. The fixing unit 9 includes a heating roller 9a and a pressure roller 9b.

### Image-Forming Process

Next, an image-forming process will be briefly described. The image bearing member (hereinbelow, a “drum 62”) is rotated in the direction of arrow R at a predetermined peripheral speed (process speed) according to a print start signal. The drum 62, serving as the image bearing member, bears a toner image thereon.

A charging roller 66 supplied with a bias voltage is brought into contact with the circumference of the drum 62, uniformly charging the circumference of the drum 62.

The exposure unit 3 outputs a laser beam L according to image information. The laser beam L passes through an exposure window 74 provided in the top surface of the cartridge B and is scanned across the circumference of the drum 62.

Thus, an electrostatic latent image according to the image information is formed on the circumference of the drum 62.

Meanwhile, as shown in FIG. 3, in a developing unit 20, toner T in a toner chamber 29 is stirred and conveyed by the rotation of a conveyance member 43 and then directed to a toner-supply chamber 28.

Due to a magnetic force of a magnet roller 34 (stationary magnet), the toner T is born on the surface of a developing roller 32.

A developing blade 42 charges the toner T by friction and controls the thickness of the toner T on the circumference of the developing roller 32.

The toner T is then transferred onto the electrostatic latent image on the drum 62, making a visible toner image.

Furthermore, as shown in FIG. 2, the sheet material P stored at the lower portion of the apparatus body A is fed from the sheet tray 4 by the pick-up roller 5a, the feeding roller pair 5b, and the conveying roller pair 5c, at the same time when the laser beam L is output.

The sheet material P having passed through the transfer guide 6 is fed to a transfer position between the drum 62 and the transfer roller 7. The toner image is transferred from the drum 62 to the sheet material P at this transfer position.

The sheet material P, onto which the toner image has been transferred, is separated from the drum 62 and conveyed to the fixing unit 9 along the conveyance guide 8. The sheet material P then passes through the nip between the heating roller 9a and the pressure roller 9b constituting the fixing unit 9.

The toner image pressed and heated at the nip is fixed to the sheet material P. The sheet material P having gone through the fixing process is conveyed to the discharge roller pair 10 and discharged onto the discharge tray 11.

Meanwhile, as shown in FIG. 3, toner remaining on the circumference of the drum 62 is removed by a cleaning member (hereinbelow, a “cleaning blade 77”) after the transfer of the toner image, and the drum 62 is used in another image-forming process. The toner removed from the drum 62 is recovered in a waste toner chamber 71b of a cleaning container 71.

The charging roller 66, the developing roller 32, and the cleaning blade 77 constitute process means that acts on the drum 62.

### Attachment and Removal of Cartridge

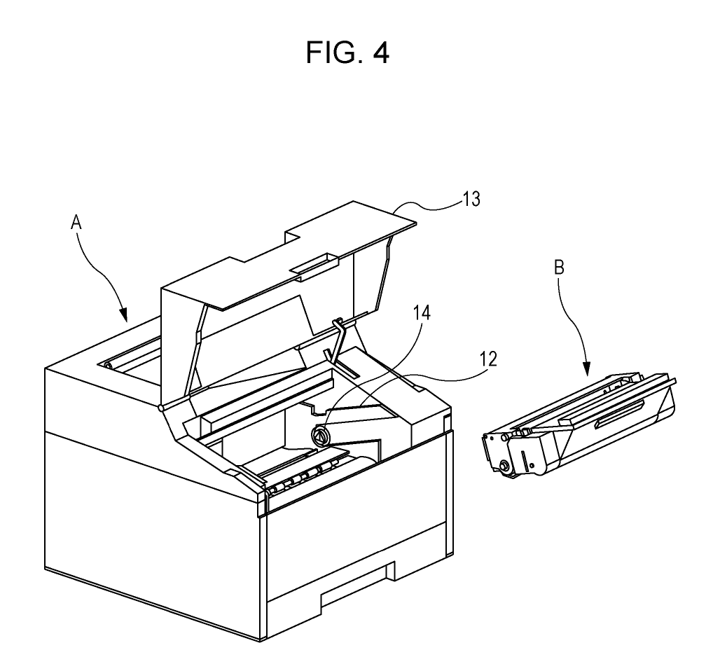

Next, attachment and removal of the cartridge B to the apparatus body A will be described with reference to FIG. 4.

FIG. 4 is a perspective view of the cartridge B and the apparatus body A with a cover 13 open so that the cartridge B can be attached or removed.

The cover 13 is attached to the apparatus body A in a pivotable manner. Guide rails 12, along which the cartridge B is fitted into the apparatus body 1, are provided under the cover 13.

A driving shaft 14 that is driven by a motor (not shown) provided in the apparatus body A is engaged with the driving-force receiving portion 63a of the cartridge B (FIG. 6).

Thus, the drum 62 connected to the driving-force receiving portion 63a receives a driving force from the apparatus body A and rotated.

Furthermore, the charging roller 66 and the developing roller 32 are powered by a power-supply portion (not shown) of the apparatus body A.

### Overall Configuration of Cartridge

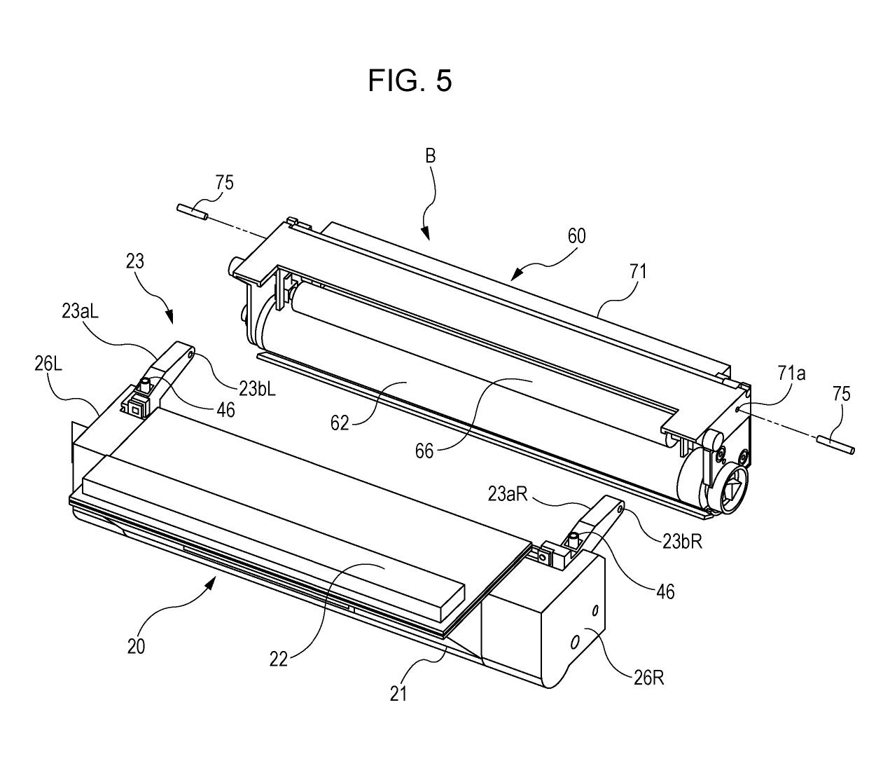

Next, the overall configuration of the cartridge B will be described with reference to FIGS. 3 and 5.

FIG. 5 is a perspective view showing the configuration of the cartridge B.

The cartridge B is composed of the cleaning unit 60 and the developing unit 20.

The cleaning unit 60 includes the cleaning container 71, the drum 62, the charging roller 66, the cleaning blade 77, etc.

The developing unit 20 includes a toner container 21, a lid 22, a developing container 23, a first side member 26L, a second side member 26R, a developing blade 42, the developing roller 32, the magnet roller 34, the conveyance member 43, toner T, urging members 46, etc.

The cartridge B is formed of the cleaning unit 60 and the developing unit 20 that are joined with joining members 75 so as to be pivotable with respect to each other.

More specifically, pivot holes 23bL and 23bR parallel to the developing roller 32 are provided in the tips of arms 23aL and 23aR provided at both ends of the developing container 23 in the longitudinal direction of the developing unit 20 (the axial direction of the developing roller 32).

Furthermore, fitting holes 71a into which the joining members 75 are fitted are provided in the cleaning container 71, at both ends in the longitudinal direction thereof.

By positioning the arms 23aL and 23aR with respect to the cleaning container 71 and inserting the joining members 75 into the pivot holes 23bL and 23bR and the fitting holes 71a, the cleaning unit 60 and the developing unit 20 are joined to each other so as to be pivotable about the joining members 75.

At this time, the urging members 46 attached to the base portions of the arms 23aL and 23aR come into contact with the cleaning container 71, urging the developing unit 20 toward the cleaning unit 60 so as to pivot about the joining members 75.

Thus, the developing roller 32 is reliably urged toward the drum 62.

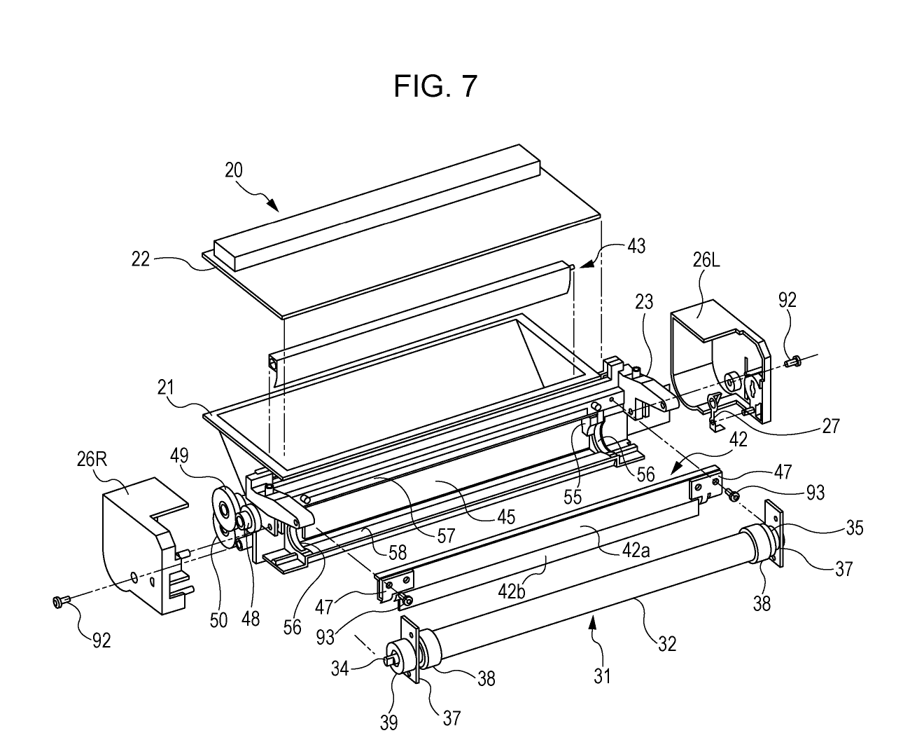

The developing roller 32 is maintained at a predetermined distance from the drum 62 by space-maintaining members 38 (FIG. 7) attached to the both ends of the developing roller 32.

### Configuration of Cleaning Unit

Next, the configuration of the cleaning unit 60 will be described with reference to FIG. 6.

FIG. 6 is a perspective view showing the configuration of the cleaning unit 60.

The cleaning blade 77 composed of a supporting member 77b made of metal and an elastic member 77a made of an elastic material, such as urethane rubber, is disposed at a predetermined position with respect to the cleaning container 71 made of resin.

The elastic member 77a is brought into contact with the drum 62 to remove residual toner from the circumference of the drum 62.

The removed toner is stored in the waste toner chamber 71b (FIG. 3) of the cleaning unit 60.

A first sealing member 82, second sealing members 83, third sealing members 84, and a fourth sealing member 85 are fixed at predetermined positions of the cleaning container 71 with, for example, a double-sided adhesive tape.

The first sealing member 82 is provided in the longitudinal direction and prevents the waste toner from leaking from the back of the supporting member 77b of the cleaning blade 77.

The second sealing members 83 prevent the waste toner from leaking from the both ends of the elastic member 77a of the cleaning blade 77 in the longitudinal direction.

The third sealing members 84 prevent the waste toner from leaking from the both ends of the elastic member 77a of the cleaning blade 77 in the longitudinal direction and also wipe the toner deposited on the drum 62.

The fourth sealing member 85 is provided in the longitudinal direction so as to be in contact with the drum 62 and prevents the waste toner from leaking from the upstream side of the cleaning blade 77 in the rotation direction of the drum 62.

An electrode plate 81, urging members 68, and charging roller bearings 67L and 67R are attached to the cleaning container 71.

A shaft 66a of the charging roller 66 is fitted to the charging roller bearings 67L and 67R.

The charging roller 66 is urged toward the drum 62 by the urging members 68 and supported by the charging roller bearings 67L and 67R so as to be rotatable. The charging roller 66 is rotated by the rotation of the drum 62.

The electrode plate 81, the urging members 68, the charging roller bearing 67L, and the shaft 66a have conductivity. The electrode plate 81 is in contact with a power-supply portion (not shown) of the apparatus body A. The charging roller 66 is powered through a power-supply path composed of these components.

The drum 62 is joined to a flange 64 and a flange 63 by, for example, caulking, bonding, or welding, thereby forming an image-bearing-member unit (hereinbelow, a “drum unit 61”).

A ground contact or the like (not shown) is connected to the flange 64. The flange 63 has the driving-force receiving portion 63a through which a driving force from the apparatus body A is received and a flange gear portion 63b through which the driving force is transmitted to the developing roller 32.

A bearing member 76 is fixed to the driving side of the cleaning container 71 with screws 90, and a drum shaft 78 is securely press-fitted to the non-driving side of the cleaning container 71.

The bearing member 76 is fitted to the flange 63, and the drum shaft 78 is fitted to a hole 64a in the flange 64.

Thus, the drum unit 61 is supported by the cleaning container 71 so as to be rotatable.

A protection member 79 is supported by the cleaning container 71 in a pivotable manner so as to protect (i.e., block light) and expose the drum 62.

An urging member 80 attached to a shaft 79aR of the protection member 79 on the driving side urges the protection member 79 in a direction of protecting the drum 62.

A shaft 79aL on the non-driving side and the shaft 79aR on the driving side of the protection member 79 are fitted to bearing portions 71cL and 71cR of the cleaning container 71, respectively.

### Developing Unit

Next, the configuration of the developing unit 20 will be described with reference to FIG. 7.

FIG. 7 is a perspective view showing the configuration of the developing unit 20.

A developing frame body composed of the toner container 21, the lid 22, and the developing container 23 forms the toner chamber 29, in which toner is stored, and the toner-supply chamber 28 (FIG. 3). The toner container 21, the lid 22, and the developing container 23 are joined together by, for example, welding.

The non-driving side of the conveyance member 43 is supported by the toner container 21, and the driving side of the conveyance member 43 is supported by a conveyance gear 50 attached to the toner container 21. Thus, the conveyance member 43 is rotated in the toner chamber 29 by the conveyance gear 50.

A toner sealing member 45 is heat-welded to the toner container 21 and divides the toner chamber 29 and the toner-supply chamber 28. Thus, the toner T is prevented from leaking from the toner chamber 29 while the cartridge B is transported.

When a user removes the toner sealing member 45, the toner T is supplied to the toner-supply chamber 28.

First sealing members 55, second sealing members 56, a third sealing member 57, and a fourth sealing member 58 are fixed at predetermined positions of the developing container 23 with, for example, a double-sided adhesive tape.

The first sealing members 55 prevent the toner T from leaking from the both ends of an elastic member 42b of the developing blade 42 in the longitudinal direction.

The second sealing members 56 prevent the toner T from leaking from the both ends of the developing roller 32 in the longitudinal direction.

The third sealing member 57 is provided in the longitudinal direction and prevents the toner T from leaking from the back of a supporting member 42a of the developing blade 42.

The fourth sealing member 58 is provided in the longitudinal direction so as to be in contact with the developing roller 32 and prevents the toner T from leaking from the lower side of the developing roller 32.

The developing blade 42 is composed of the supporting member 42a made of metal and the elastic member 42b made of an elastic material, such as urethane rubber. Both ends of the supporting member 42a are fixed at predetermined positions of the developing container 23 with screws 93 together with cleaning members 47.

The elastic member 42b is brought into contact with the developing roller 32, controlling the amount of toner on the circumference of the developing roller 32 and applying frictional charge.

The cleaning members 47 are brought into contact with the surfaces of the ends of the developing roller 32, thereby cleaning the toner deposited thereon.

The developing roller unit 31 includes the developing roller 32, the magnet roller 34, a flange 35, the space-maintaining members 38, bearing members 37, a developing roller gear 39, etc.

The magnet roller 34 is inserted into the non-driving end of the developing roller 32, and the flange 35 is securely press-fitted to the end.

The flange 35 has a conductive electrode wire (not shown) therein, which is in contact with the developing roller 32 and an electrode plate 27.

The conductive electrode plate 27 is fixed to the first side member 26L.

The electrode plate 27 is in contact with the power-supply portion (not shown) of the apparatus body A, and power is supplied to the developing roller 32 through the power-supply path composed of the electrode plate 27 and the electrode wire.

The space-maintaining members 38 are attached to the both ends of the developing roller 32, and the bearing members 37 are disposed on the outer side of the space-maintaining members 38. Furthermore, the developing roller gear 39 is disposed on the outer side of the space-maintaining member 38 on the driving side.

The developing roller 32 is supported so as to be rotatable by the bearing members 37 disposed at both ends.

A first gear 48 and a second gear 49, serving as driving-force transmitting members, are attached to the developing frame body so as to be rotatable.

Thus, the driving force from the apparatus body A is transmitted to the developing roller 32 and the conveyance member 43 via the flange gear portion 63b (FIG. 6), the developing roller gear 39, the first gear 48, the second gear 49, and the conveyance gear 50 that are meshed together and rotated.

The first side member 26L and the second side member 26R are fixed to the both ends of the developing frame body in the longitudinal direction with screws 92.

The bearing members 37 of the developing roller unit 31 are held by the first side member 26L and the second side member 26R.

### Cleaning-Blade Support Structure of Cleaning Container

The relative positions of the drum 62 and the cleaning blade 77 in the directions of arrows E and F (FIG. 3), which are directions perpendicular to the shaft of the drum 62, need to be precisely and reliably maintained throughout the temperature range that is expected during use of the image forming apparatus.

If these components are assembled with incorrect relative positions, or if their relative positions are changed due to deformation caused by a change in temperature, faulty cleaning may occur.

Therefore, relative positions of the cleaning container 71 and the cleaning blade 77 in the directions of arrows E and F (FIG. 3), which are directions perpendicular to the shaft of the drum 62, also need to be precisely and reliably maintained throughout the temperature range that is expected during use of the image forming apparatus.

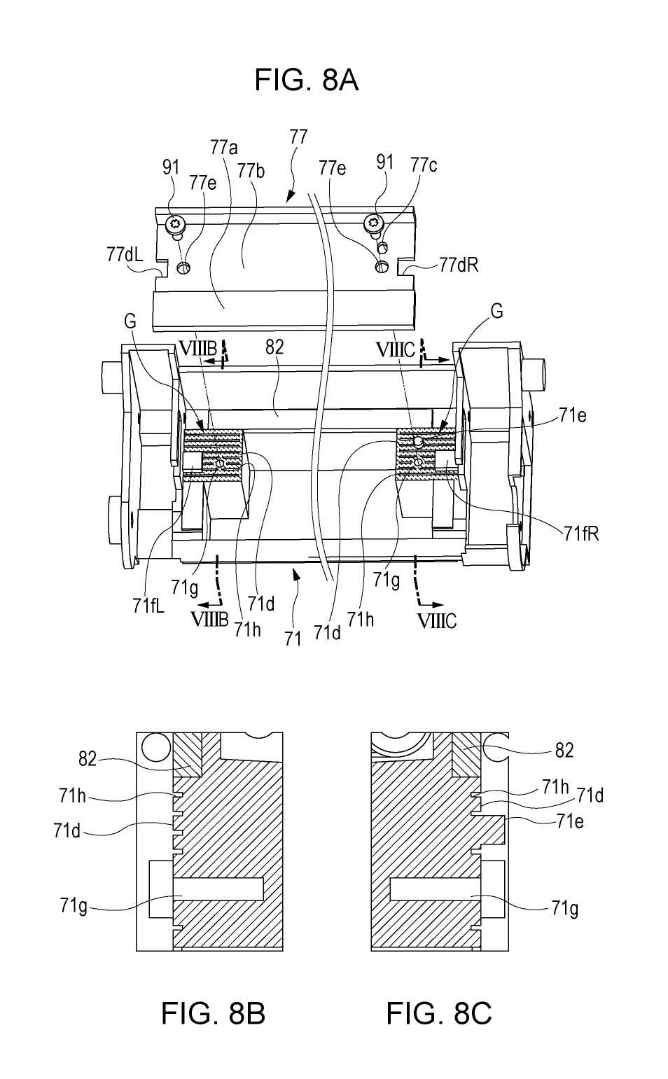

Referring to FIGS. 8A to 8C, the support structure of the cleaning blade 77 configured to support the cleaning container 71 will be described.

The cleaning container 71 has support surfaces 71d, a shaft 71e, a projection 71fL, and a projection 71fR. The supporting member 77b has a hole 77c, a notch 77dL, and a notch 77dR. The support surfaces 71d come into contact with the supporting member 77b.

By fitting the shaft 71e to the hole 77c, the cleaning blade 77 is positioned with respect to the cleaning container 71 in the longitudinal direction.

The positioning is performed at only one location in the longitudinal direction, by fitting the shaft 71e to the hole 77c. Therefore, when there is a difference in the amount of thermal expansion between the cleaning container 71 made of resin and the supporting member 77b made of metal due to the difference in the thermal expansion coefficient, the contact portions except for the above-mentioned one location slide relative to each other (this will be described in detail below). In other words, the cleaning container 71 and the supporting member 77b are joined such that they can move relatively to each other in the longitudinal direction, even if the thermal expansion occurs.

Furthermore, the position of the cleaning blade 77 with respect to the cleaning container 71 in a direction perpendicular to the shaft of the drum 62 is determined by bringing the support surfaces 71d into contact with the supporting member 77b and by fitting the projections 71fL and 71fR to the notches 77dL and 77dR, respectively.

The cleaning blade 77 is supported by the cleaning container 71 by inserting screws 91 at both ends in the longitudinal direction into holes 77e in the cleaning blade 77 and fastening them with screw fitting holes 71g in the cleaning container 71. The screw fitting holes 71g are provided in a direction intersecting the support surfaces 71d.

At this time, lubricant G, such as grease, is applied to the support surfaces 71d. Furthermore, the support surfaces 71d are provided with a plurality of grooves 71h, which extend in the longitudinal direction and are recessed from the support surfaces 71d, to reduce the contact area between the support surfaces 71d and the supporting member 77b. Thus, the coefficient of static friction between the support surfaces 71d and the supporting member 77b is reduced.

Although the lubricant G is applied to the support surfaces 71d when the cleaning blade 77 is fastened to the cleaning container 71 in this embodiment, the lubricant G may be applied to the supporting member 77b.

Now, the advantages achieved by this support structure will be described in comparison with a typical conventional structure in which no lubricant is used or no grooves 71h are provided.

First, the accuracy of the relative positions of the cleaning container 71 and the cleaning blade 77 in the directions perpendicular to the shaft of the drum 62 (the directions of arrows E and F in FIG. 3) at the time of assembly will be described.

The positioning structure of the cleaning container 71 and the cleaning blade 77 is the same as that of the conventional structure. Accordingly, the accuracy of the relative positions achieved with this support structure is the same as that of the conventional structure at the time of assembly.

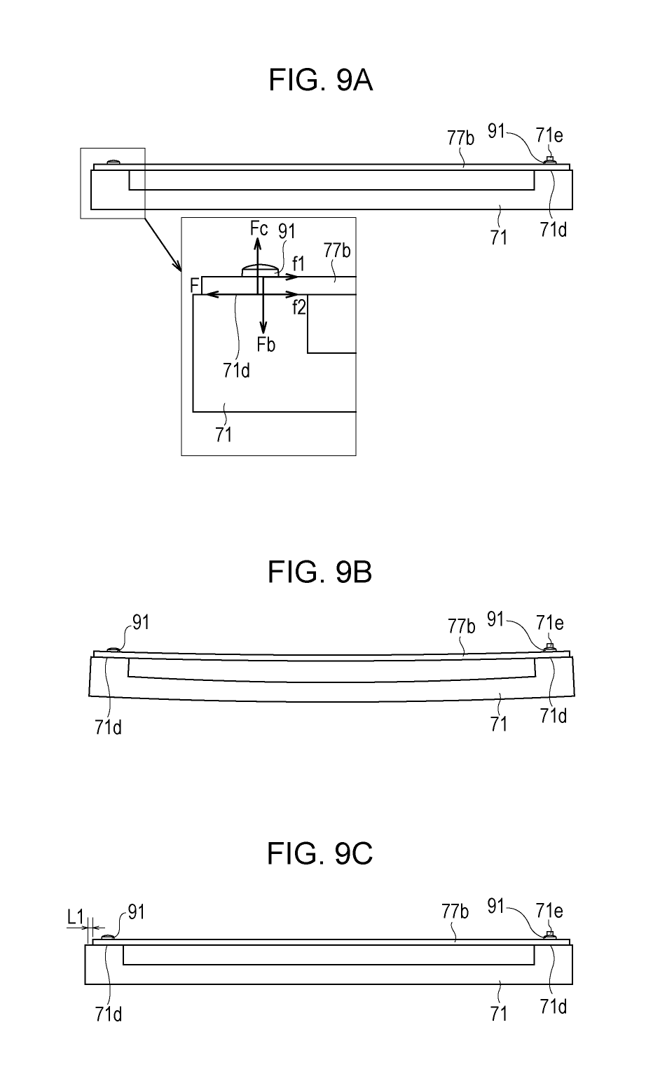

Next, the accuracy of the relative positions of the cleaning container 71 and the cleaning blade 77 in the directions perpendicular to the shaft of the drum 62 (the directions of arrows E and F in FIG. 3) when the temperature is changed (in this case, when the temperature rises) will be described with reference to FIGS. 9A to 9C.

The thermal expansion coefficient is different between the cleaning container 71 made of resin and the supporting member 77b made of metal. Therefore, when the temperature rises, the supporting member 77b is subjected to a force F due to a difference in the amount of thermal expansion between the fastening portions fastened by the screws 91 at both ends (FIG. 9A).

Let us assume that Fb is the force with which the screws 91 press the supporting member 77b, Fc is the reaction force from the cleaning container 71, μ1 is the coefficient of static friction between the screws 91 and the supporting member 77b, and μ2 is the coefficient of static friction between the support surfaces 71d and the supporting member 77b. The static friction f1=μ1×Fb, and the static friction f2=μ2×Fc.

With the conventional structure, F is smaller than f1+f2. Thus, the support surfaces 71d and the supporting member 77b do not slide relative to each other, and the cleaning container 71 and the supporting member 77b are deformed due to the difference in the amount of thermal expansion, as shown in FIG. 9B.

In contrast, with the structure of the present invention, because the application of the lubricant G and the provision of the grooves 71h decrease μ2, achieving F>f1+f2, and because the positioning is performed at only one location in the longitudinal direction, the support surfaces 71d and the supporting member 77b slide relative to each other by an amount corresponding to the difference in the amount of thermal expansion, L1, as shown in FIG. 9C. Accordingly, even when the temperature is changed, the relative positions of the cleaning container 71 and the cleaning blade 77 can be precisely maintained in the direction perpendicular to the shaft of the drum 62 (the directions of arrows E and F in FIG. 3).

Furthermore, because μ2 can be decreased with a simple structure, i.e., the application of the lubricant G and the provision of the grooves 71h, costly surface treatment of the support surfaces 71d and the supporting member 77b is unnecessary.

Note that, because the portion provided with the lubricant G is not exposed to a portion facing the drum 62, there is a low risk of the lubricant G being deposited on the drum 62.

Referring again to FIG. 9A, the support strength of the cleaning container 71 that supports the cleaning blade 77 by fastening the screws 91 will be described.

The support strength is determined by the force Fb, the coefficient of static friction μ1, and the coefficient of static friction between the screw portions (not shown) of the screws 91 and the cleaning container 71. Because they are common to the support structure of the present invention and the conventional structure, the support strength of the support structure of the present invention is the same as that of the conventional structure.

That is, unlike the structure in which at least one portion of the cleaning blade 77 is fastened to the cleaning container via an elastic member that presses the cleaning blade 77, the support strength does not decrease. In short, the cleaning unit 60 used in the image forming apparatus is configured such that the cleaning blade 77 is supported by the cleaning container 71 by fastening the screws 91, with the lubricant G interposed between the support surfaces 71d and the supporting member 77b.

Furthermore, the support surfaces 71d are provided the plurality of grooves 71h extending in the longitudinal direction.

This structure enables the support surfaces 71d and the supporting member 77b to slide relative to each other, making it possible to absorb the difference in the amount of thermal expansion between the cleaning container 71 and the supporting member 77b generated by a change in temperature.

That is, it is possible to precisely and reliably maintain the relative positions of the cleaning container 71 and the cleaning blade 77 in the directions perpendicular to the shaft of the drum 62 (the directions of arrows E and F in FIG. 3) throughout the temperature range that is expected during use of the image forming apparatus with a simple structure. Accordingly, the faulty cleaning can be avoided.

It is to be understood that, unless otherwise specifically indicated, the functions, materials, shapes, and relative positions of the components described in this embodiment are not intended to limit the scope of the invention.

### Second Embodiment

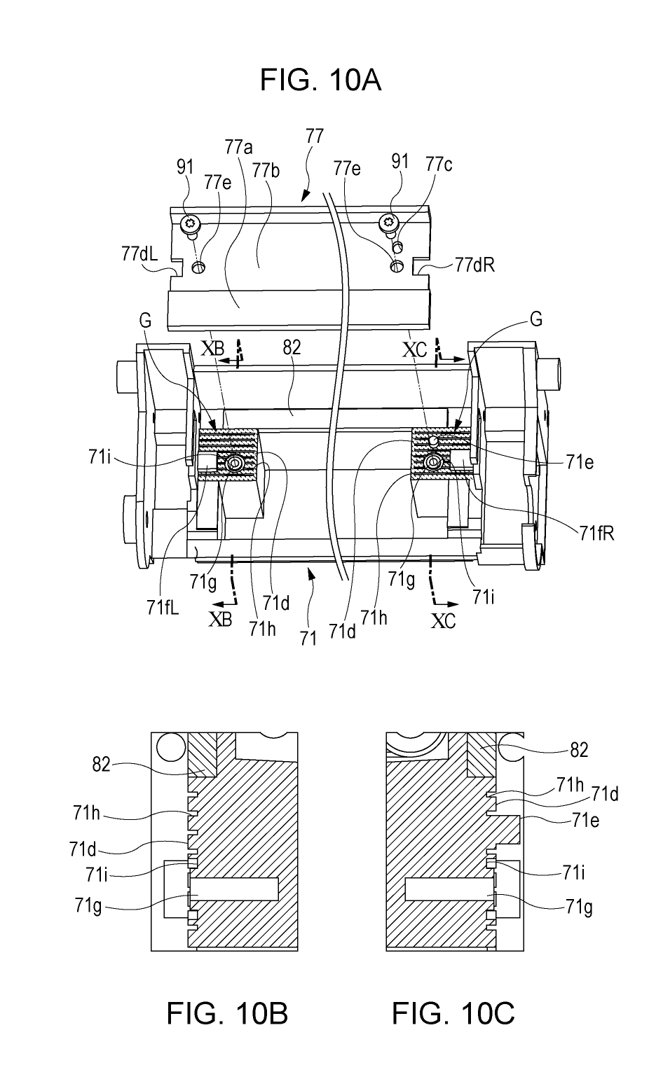

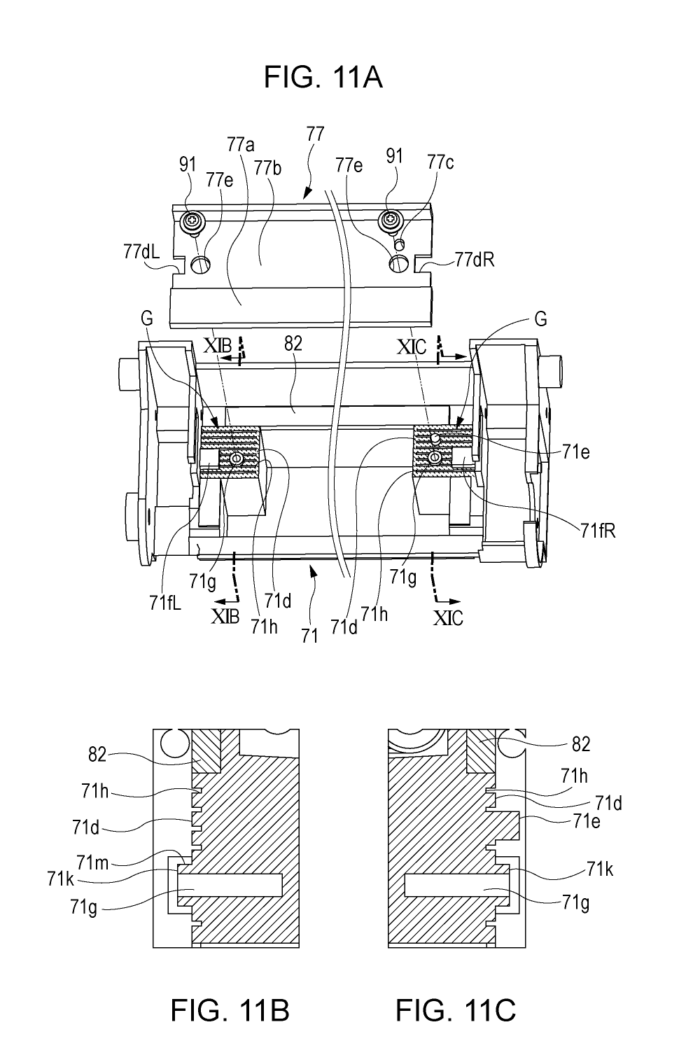

Referring to FIGS. 10A to 10C and 11A to 11C, a second embodiment of the present invention will be described.

In this embodiment, the configurations different from those according to the above-described embodiment will be described in detail. The materials, shapes, and the like are the same as those according to the above-described embodiment, unless specifically described otherwise. The same components are denoted by the same reference numerals and detailed descriptions thereof will be omitted.

In the first embodiment, the cleaning blade 77 is supported by the cleaning container 71 by fastening the screws 91, with the lubricant G interposed between the support surfaces 71d and the supporting member 77b.

Furthermore, the support surfaces 71d are provided with the plurality of grooves 71h extending in the longitudinal direction.

In this embodiment, in addition to them, as shown in FIGS. 10A to 10C, recesses 71i that are recessed further than the surfaces provided with the screw fitting holes 71g and the support surfaces 71d are provided in the cleaning container 71, at positions between the screw fitting holes 71g and the support surfaces 71d.

This structure also enables the support surfaces 71d and the supporting member 77b to slide relative to each other, making it possible to absorb the difference in the amount of thermal expansion between the cleaning container 71 and the supporting member 77b generated by a change in temperature, as in the first embodiment.

Furthermore, in this embodiment, even if the lubricant G squeezed between the support surfaces 71d and the supporting member 77b flows outward, the lubricant G is stopped by the recesses 71i and does not enter the screw fitting holes 71g. Accordingly, a decrease of the support strength exerted by fastening the screws 91 can be prevented.

Although the recesses 71i are provided in the cleaning container 71 in this embodiment, the screw fitting holes 71g may be provided in surfaces 71k protruding toward the supporting member 77b further than the support surfaces 71d, as shown in FIGS. 11A to 11C. In this case too, even if the lubricant G squeezed between the support surfaces 71d and the supporting member 77b flows outward, the lubricant G is stopped by surfaces 71m and does not enter the screw fitting holes 71g. Accordingly, a decrease of the support strength exerted by fastening the screws 91 can be prevented.

It is to be understood that, unless otherwise specifically indicated, the functions, materials, shapes, and relative positions of the components described in this embodiment are not intended to limit the scope of the invention.

### Third Embodiment

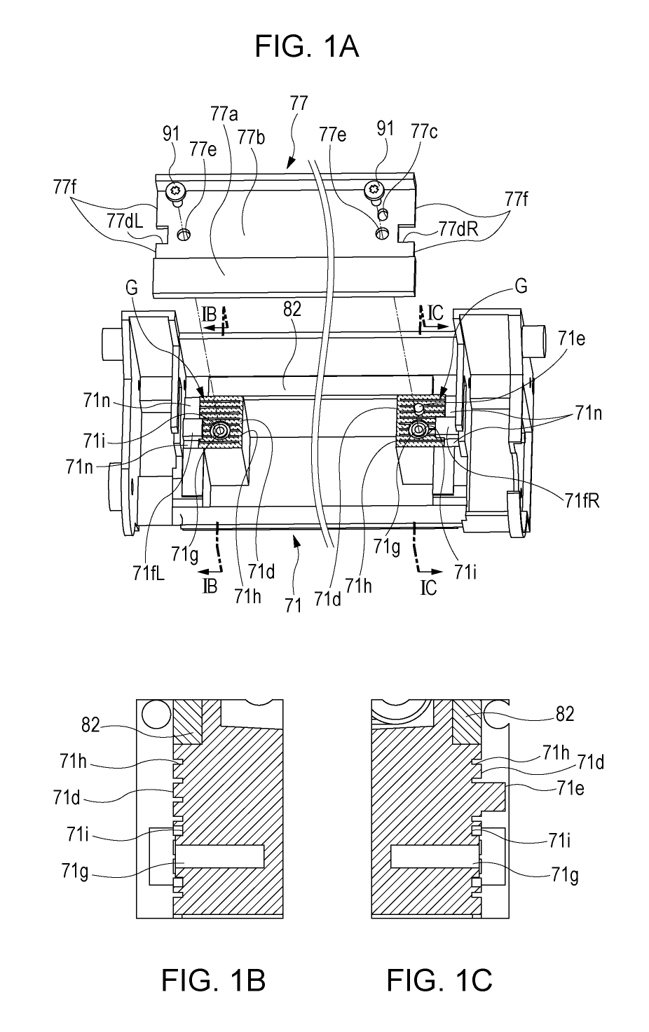

Referring to FIG. 1, a third embodiment of the present invention will be described.

In this embodiment, the configurations different from those according to the above-described embodiment will be described in detail. The materials, shapes, and the like are the same as those according to the above-described embodiment, unless specifically described otherwise. The same components are denoted by the same reference numerals and detailed descriptions thereof will be omitted.

In the first embodiment, the cleaning blade 77 is supported by the cleaning container 71 by fastening the screws 91, with the lubricant G, such as grease, interposed between the support surfaces 71d and the supporting member 77b.

Furthermore, the support surfaces 71d are provided with the plurality of grooves 71h extending in the longitudinal direction.

In the second embodiment, the recesses 71i that are recessed further than the support surfaces 71d are provided in the cleaning container 71, at positions between the screw fitting holes 71g and the support surfaces 71d.

In this embodiment, in addition to them, as shown in FIG. 1, the support surfaces 71d are provided with recesses 71n so that the ends of the supporting member 77b in the longitudinal direction are not in contact with the support surfaces 71d.

This structure enables the support surfaces 71d and the supporting member 77b to slide relative to each other, making it possible to absorb the difference in the amount of thermal expansion between the cleaning container 71 and the supporting member 77b generated by a change in temperature, as in the first embodiment.

Furthermore, as in the second embodiment, even if the lubricant G squeezed between the support surfaces 71d and the supporting member 77b flows outward, the lubricant G is stopped by the recesses 71i and does not enter the screw fitting holes 71g. Accordingly, a decrease of the support strength exerted by fastening the screws 91 can be prevented.

Furthermore, in this embodiment, when the support surfaces 71d and the supporting member 77b slide relative to each other when the temperature is changed, edges 77f at both ends of the supporting member 77b in the longitudinal direction can be prevented from interfering with the support surfaces 71d and serving as the resistance to the sliding.

It is to be understood that, unless otherwise specifically indicated, the functions, materials, shapes, and relative positions of the components described in this embodiment are not intended to limit the scope of the invention.

Although grease is used as the lubricant G in the above-described first to third embodiments, other liquid lubricants, such as oil, may be used.

Furthermore, although the cleaning blade is fastened to the cleaning container without using an elastic member or without any surface treatment of the support surface in the first to third embodiments, other configurations are also possible. For example, the configuration of the present invention, i.e., the configuration in which lubricant is used, may be combined with a configuration in which the support surface is surface-treated or a configuration in which the cleaning blade is fastened to the cleaning container using an elastic member. However, the use of lubricant eliminates the need of surface treatment and elastic member, achieving cost reduction.

The use of lubricant does not deteriorate the design flexibility of the support strength.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2010-273910 filed Dec. 8, 2010, which is hereby incorporated by reference herein in its entirety.

What is claimed is:

1. A cleaning unit used in an image forming apparatus, the cleaning unit comprising:
a cleaning member configured to remove toner deposited on an image bearing member that bears a toner image, the cleaning member including an elastic member provided so as to be in contact with the image bearing member in a longitudinal direction, and a supporting member that supports the elastic member; and
a cleaning container in which the toner removed by the cleaning member is recovered, the cleaning container having a thermal expansion coefficient different from that of the supporting member,
wherein the cleaning container has support surfaces at both ends in the longitudinal direction thereof to which the supporting member is attached and has screw fitting holes provided in a direction intersecting the support surfaces,
wherein the supporting member is fitted to the cleaning container by fitting screws to the screw fitting holes, and
wherein lubricant is applied between the support surfaces and the supporting member.

2. The cleaning unit according to claim 1,
wherein recesses that are recessed further than surfaces provided with the screw fitting holes and the support surfaces are provided between the screw fitting holes and the support surfaces in the cleaning container.

3. The cleaning unit according to claim 1,
wherein the screw fitting holes are provided in surfaces that protrude toward the supporting member further than the support surfaces.

4. The cleaning unit according to claim 1,
wherein the ends of the supporting member in the longitudinal direction are not in contact with the support surfaces.

5. The cleaning unit according to claim 1,
wherein the thermal expansion coefficient of the supporting member is smaller than that of the cleaning container.

6. The cleaning unit according to claim 1,
wherein the supporting member is made of metal, and the cleaning container is made of resin.

7. The cleaning unit according to claim 1,
wherein the image bearing member is supported by a frame body in which the cleaning container is disposed.

8. An image forming apparatus comprising:
an image bearing member configured to bear a toner image, and
the cleaning unit according to claim 1.
